(19) United States
(12) Patent Application Publication
(10) Pub. No.: US 2002/0059155 A1
(43) Pub. Date: May 16, 2002

(54) Information management apparatus, information management system, and storage medium storing information management software

(76) Inventors: Hidenori Takata, Kanagawa (JP); Yoshiaki Kurasawa, Kanagawa (JP); Kyoichi Hoshino, Chiba (JP); Keiko Furuyama, Chiba (JP); Toshihiko Wada, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/853,684

(22) Filed: May 14, 2001

(30) Foreign Application Priority Data
May 15, 2000 (JP) 141773/2000

(51) Int. Cl. G06F 17/00

(52) U.S. Cl. 706/45

(57) ABSTRACT

A storage medium stores software and management software for managing the software. The management software comprises the step of restoring and changing a management state of the software.

### BACKGROUND OF THE INVENTION

1.Field of the Invention

The present invention relates to apparatus and methods for controlling the use of software, and media storing them.

2. Related Background Art

Conventionally, software annexed to a supplement to a magazine is to be used within a limited term (e.g., 60 days).

In the disclosure of Japanese Patent Registration No. 2810033, since battery is supplied by a FD (Floppy Disk), there is a fear of illegally copying the FD for battery. Besides, since mailing the FD requires a long time (time lag), there is a fear of interrupting the business. Further, there is a risk of losing or damaging the FD.

Next, Japanese Patent Post-Exam Publication No. 7-89305 has the following problems.

There is a problem in use termination processing. In case of processing by a host machine, when a trouble occurs in a communication device such as a modem, use termination processing is not performed, and the fee even for a non-utilization time is imposed. In case of processing by a user machine, when a stoppage of electric power or the like occurs, since use termination processing is not executed on the user machine side, there are problems that the calculation of utilization time becomes impossible, it is hard to detect an iniquity when the system date was rigged upon restarting after the stoppage of electric power, etc. Even if such a detection is possible, changing the system date in an application operating may be performed for a reason on system management (e.g., the date is returned to Dec. 30, 1999 as emergency measures for Y2K trouble). Even in such a case, if the use of the application becomes impossible, it is inconvenient.

Therefore, performing the calculation of utilization time by “From To” has a limit.

Since the fees for only referring and for frequently inputting are the same, there is a feeling of comparatively expensive in case of only referring (imposing in accordance with use is impossible).

In comparison with those, according to the present invention:

charging at real time is possible;

the fear of copying is little;

even automatically charging is possible when battery has its residual less than a predetermined amount; and

rigging the system date is meaningless because battery is charged one by one in accordance with utilization time. There is no confusion even when an application is suddenly stopped due to a stoppage of electric power or the like.

battery is so-called prepaid, there is no time lag till imposing the fee, and the management of funds on a provider side is easy. On the other hand, a user side can avoid a case of overusing before he or she knows it (exceeding his or her estimate).

### SUMMARY OF THE INVENTION

In order to realize the above-mentioned object, the present invention is characterized by a storage medium storing software and management software for managing said software, wherein the management software comprises a step of restoring and changing a management state of said software.

In order to realize the above-mentioned object, the present invention is characterized by an information processing apparatus comprising storing means for storing management software for managing software. The management software comprises means for restoring and changing a management state of said software; and

means for connecting to a predetermined site for restoring a management state of said management software by said restoring means.

In order to realize the above-mentioned object, the present invention is characterized by an information processing apparatus comprising:

means for restoring and changing a management state of management software for managing software; and

means for connecting to a predetermined site for restoring a management state of said management software by said restoring means.

In order to realize the above-mentioned object, the present invention is characterized by an information processing apparatus comprising:

means for restoring and changing a management state of management software for managing software; and

means for connecting to a predetermined site for restoring a management state of said management software by said restoring means.

In order to realize the above-mentioned object, the present invention is characterized by an information processing apparatus comprising:

means for restoring and changing a management state of management software for managing software; and

means for connecting to a predetermined site for restoring a management state of said management software by said restoring means.

The present invention is characterized by a host device to communicate with an information processing apparatus comprising:

means for restoring and changing a management state of management software for managing software; and

means for connecting to a predetermined site for restoring a management state of said management software by said restoring means. The device thereby restores the management state of said management software. The device comprises means for transmitting information for restoring the management state of said management software, in response to a request from said information processing apparatus.

### BRIEF DESCRIPTION OF THE DRAWINGS

FIG. 1 is a block diagram showing an outline of the whole of the present invention;

FIG. 2 shows data structures in a battery supply module;

FIG. 3 is a flowchart for explaining an embodiment of the present invention;

FIG. 4 is a flowchart of the battery supply module;

FIG. 5 shows a protocol between a user machine and a host machine;

FIG. 6 shows a file construction of a floppy;

FIG. 7 is a flowchart of a battery program;

FIG. 8 shows the construction of a battery floppy;

FIG. 9 shows an example of display of battery;

FIG. 10 is a flowchart for controlling display of battery;

FIG. 11 shows display of battery;

FIG. 12 is a flowchart for predicting time can be used from battery residual amount;

FIG. 13 is a flowchart for controlling charging normal battery;

FIG. 14 is a flowchart for controlling charging unlimited battery;

FIG. 15 is a flowchart for controlling charging trial battery;

FIG. 16 is a flowchart for controlling use limitation and reproduction of battery;

FIG. 17 shows display upon use limitation of battery and reproduction control;

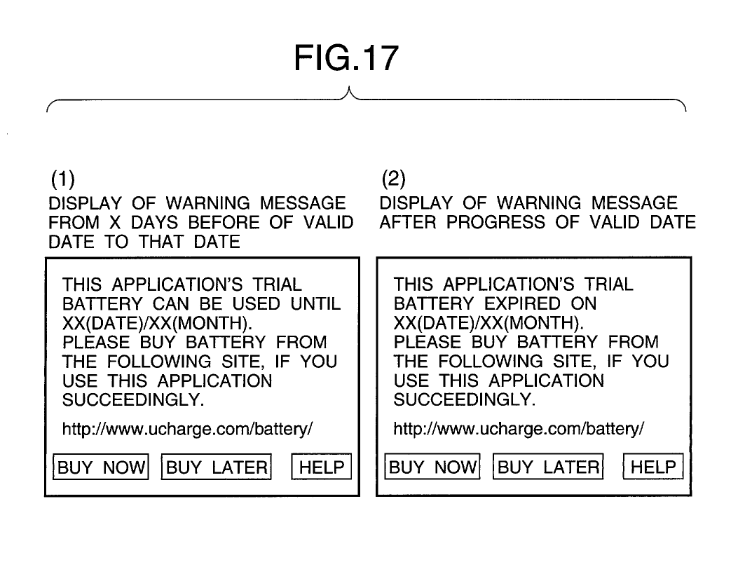

FIG. 18 is a flowchart for controlling buying battery or using present battery;

FIG. 19 shows display windows upon buying battery;

FIG. 20 is a flowchart for controlling buying battery or using present battery;

FIG. 21 shows display windows showing battery buying;

FIG. 22 is a flowchart for controlling battery on-line buying;

FIG. 23 shows display windows upon controlling battery on-line buying;

FIG. 24 is a flowchart for controlling battery on-line buying;

FIG. 25 shows display windows showing battery buying;

FIG. 26 is a flowchart for controlling imposing fee when battery is invalid;

FIG. 27 shows display windows upon controlling imposing fee when battery is invalid;

FIG. 28 is a flowchart for controlling imposing fee when battery is invalid; and

FIG. 29 shows display windows upon controlling imposing fee when battery is invalid.

### DETAILED DESCRIPTION OF THE PREFERRED EMBODIMENTS

Hereinafter, preferred embodiments of the present invention will be described with reference to the accompanying drawings.

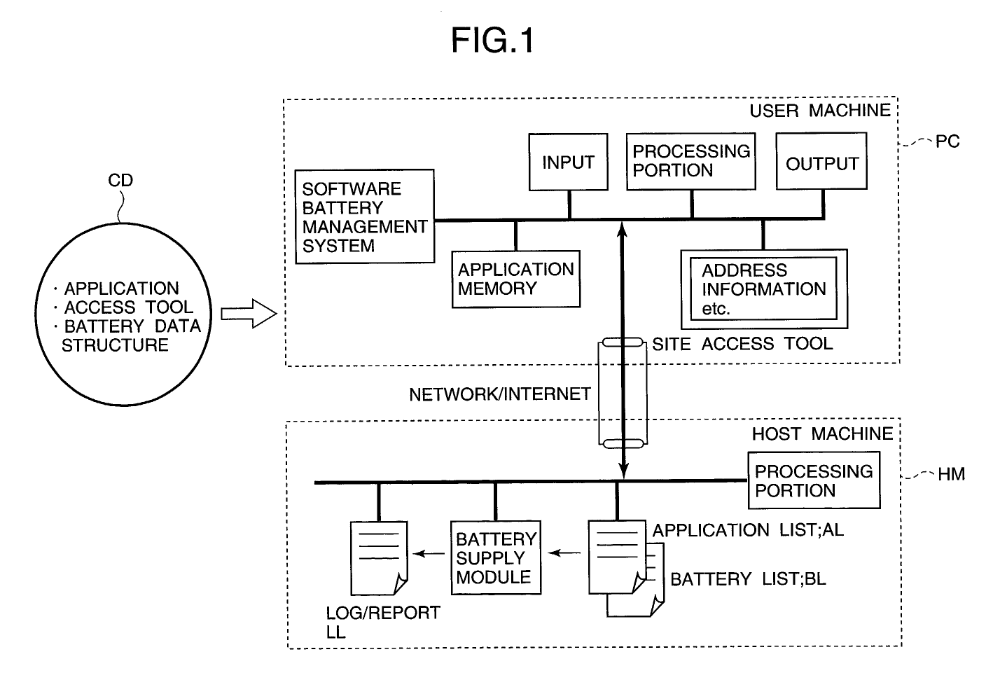

In FIG. 1, on a user machine PC where “software battery management system” exists, “site access tool (S.A.T.)” charges battery from a host machine HM in cooperation with the system.

“site access tool” is provided to a user with information on the host machine HM to be connected being beforehand incorporated in, for example, formable storage media CD, MD, FDD, or a semiconductor memory or the like. In case of receiving an offer of software through communication, it may be received through a communication medium with software.

“battery supply module” is incorporated in the host machine HM, and battery selected by the user is supplied to a predetermined place by a designated amount. The predetermined place is provided in the user machine PC or on a server.

FIG. 1 is a block diagram of the present invention. In FIG. 1, PC is a user's computer, in which at least application software downloaded from a detachable storage medium CD and set up and operation software for controlling the valid term of the application software are stored.

In the storage medium CD, application and operation software is stored. The operation software will be described in more detail. It comprises an access tool and a battery data structure list. The battery data structure list is set at a predetermined value as its initial value. After this, by rewriting the value of data in it, the use of an application can be restarted. The operation software includes a software battery management system and a site access tool.

HM is a host machine. When the valid term of the above application software on the computer PC is to be extended, it makes a communication with the host machine HM and rewrites the above-mentioned value, thereby becoming an extension of the valid term.

In the host machine HM, a log record LL of the user, an update module of the valid term, an application list AL, and a supply list SL are stored in a memory.

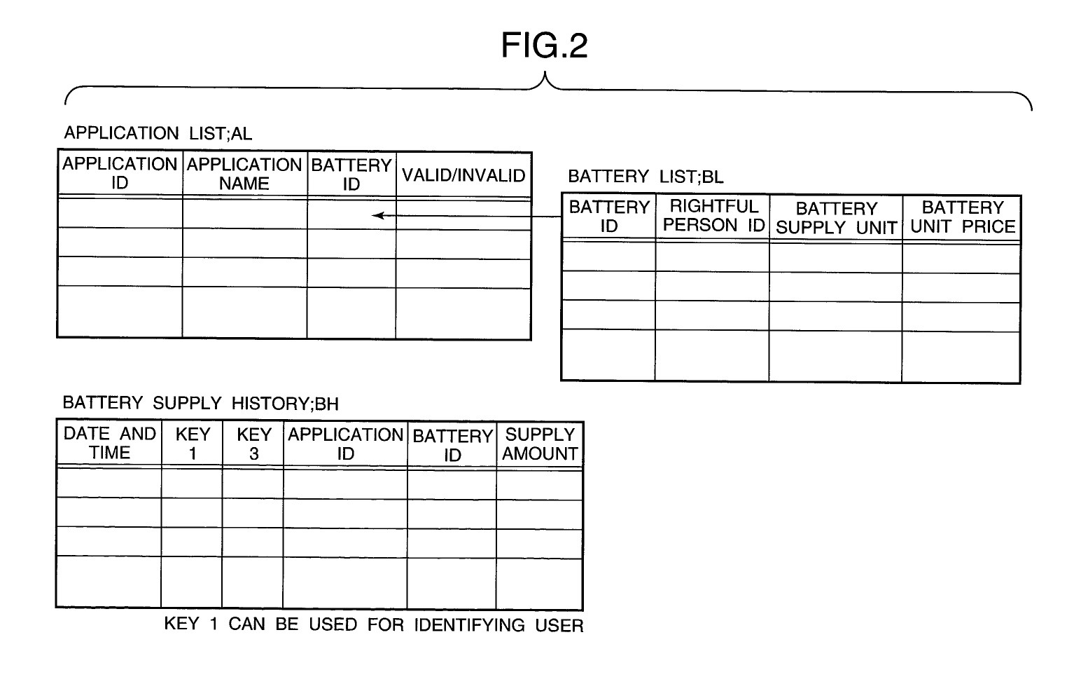

The above-mentioned application list AL, battery list BL, and battery supply history list BH are as shown in FIG. 2. With such lists, adaptation of applications, the unit price of battery, and so on can be set by every application. Here, battery means information for controlling the use of application software (for example, controlling time, times, and so on).

### Start Procedure

(1) “site access tool” of the user machine is address information of its own information host machine. In case of Internet, it is IP address or URL. It connects to the host machine HM in accordance with the information.

(2) “battery supply module” of the host machine provides list information on battery that can be provided. Such information is displayed as a list on a screen of a display device of the user machine.

(3) “site access tool” having received the battery list information inquires “software battery management system” whether or not it has already managed the respective batteries, and make a display to the user with dividing the batteries into managed ones and non-managed ones.

(4) The user selected an objective battery by moving a cursor on a desired battery and the amount from among the displayed batteries. Alternatively, the user can input a numerical value through an input device without moving the cursor.

(5) “site access tool” transmits the battery and the amount selected by the user to “battery supply module”.

(6) Based on the received battery and amount, “battery supply module” prepares battery additional information and transmits it to “site access tool”. Besides, the information at this time is stored as a log.

(7) “site access tool” having received the battery additional information passes the information to “software battery management system”, and confirms that battery has been charged.

(8) “site access tool” sends out the confirmation information to “battery supply module”.

(9) In “battery supply module”, this confirmation information is also recorded in addition to the above-mentioned log.

(10) When a series of communication is completed, “site access tool” terminates the communication with the host machine.

Of course, after battery is supplied, every time when an application is used on the user machine, the value is decreased, and the application becomes impossible to be used.

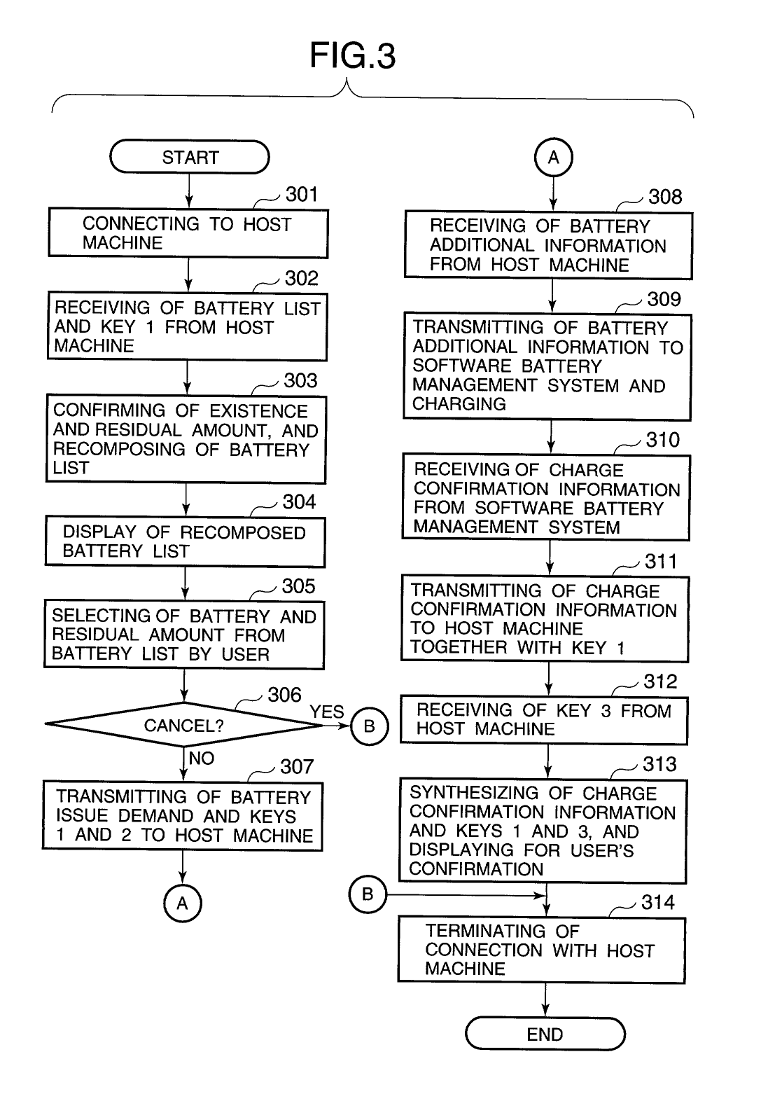

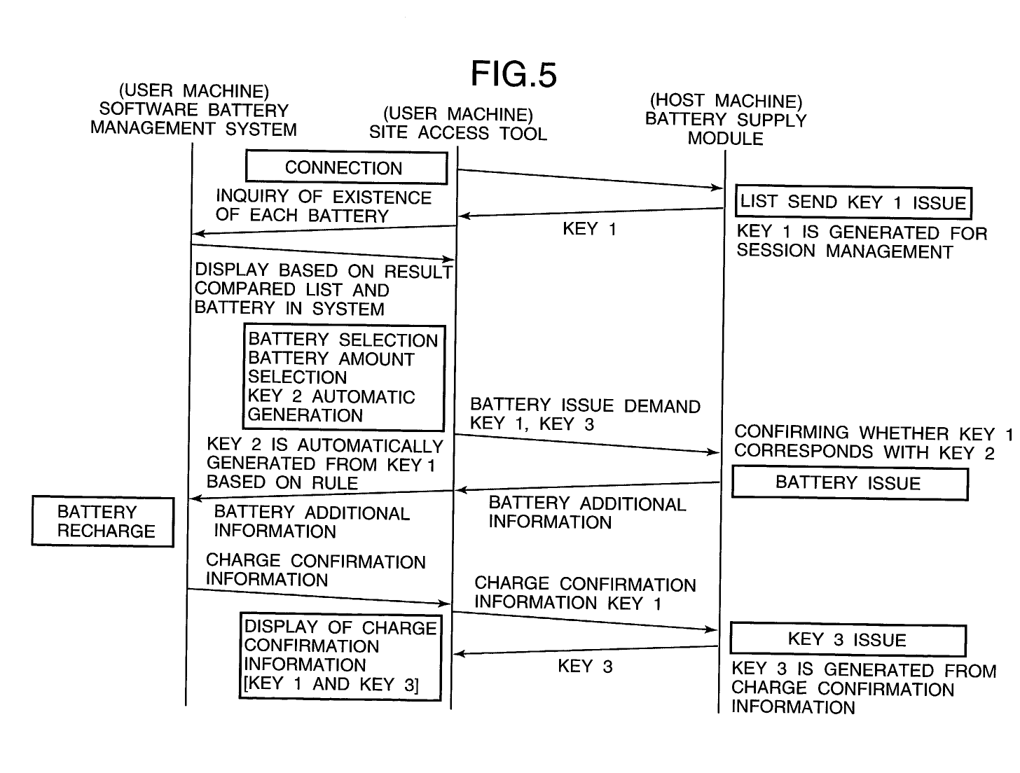

The described process will be further described with reference to the sequence flow of FIG. 5 and the control flow shown in FIG. 3. Such a control flow is a control made on the user machine PC. A program according to the control flow is stored in a memory, and it is executed by a processing portion to make a control. The following steps are executed by the processing portion.

In step 301, a connection with the host machine HM is made in accordance with IP address or URL. When the connection is made, in step 302, a battery list and a key 1 list are received from the host machine HM. Next, in step 303, confirmation of the existence and the residual amount of battery is made to the software battery management system, and the battery list is recomposed. Next, in step 304, the recomposed battery list is displayed on the display screen on the computer PC. Next, in step 305, the user operates a mouse and moves a cursor on battery and battery amount from the battery list to select battery and a battery amount. Next, in step 306, it is judged whether or not he or she cancels it. If he or she continues it, in step 307, a battery issue demand and keys are transmitted to the host machine HM. Next, in step 308, battery additional information is received from the host machine HM. In step 309, the battery additional information is transmitted to the software battery management system to charge. In step 310, charge confirmation information is received from the software battery management system. In step 311, the charge confirmation information is transmitted together with key 1 to the host machine HM. In step 312, key 3 is received from the host machine HM.

In step 313, the charge confirmation information and keys 1 and 3 are synthesized and displayed for user's confirmation. In step 314, the connection with the host machine HM is terminated.

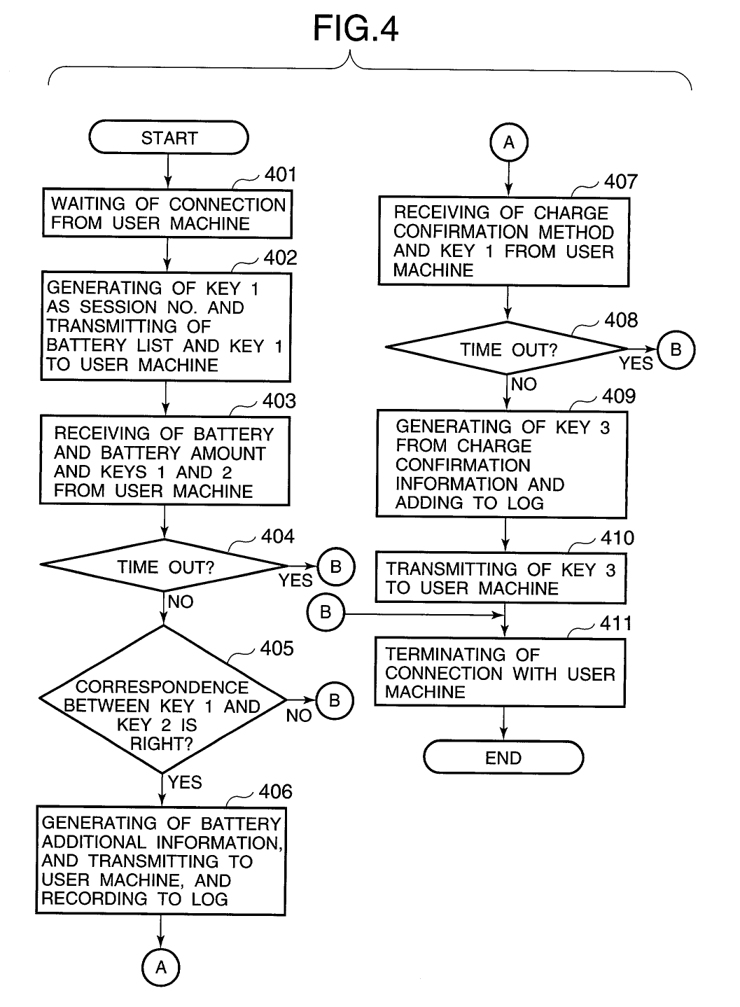

Next, with reference to the sequence of FIG. 5, the battery supply module will be described on the basis of FIG. 4. Such a control flow is a control made on the host machine HM. A program according to the control flow is stored in a memory, and it is executed by a processing portion to make a control. The following steps are executed by the processing portion.

In step 401, a connection from the user machine PC is waited for. In step 402, a key as a session number is generated, and a battery list and key 1 are transmitted to the user machine PC. In step 403, a battery amount and keys 1 and 2 are received from the user machine PC. In step 404, it is judged whether or not the time is out. If the time is not out, in step 405, it is judged whether or not key 1 corresponds to key 2. If YES, in step 406, battery additional information is generated and it is transmitted to the user machine PC and recorded in log. In step 407, charge confirmation information and key 1 are received from the user machine PC. In step 408, it is judged whether or not the time is out. If not, in step 409, key 3 is generated from the charge confirmation information, and added to log. In step 410, key 3 is transmitted to the user machine PC.

Next, in step 411, the connection with the user machine PC is terminated.

After battery is charged through such a connection, the process is transferred to the execution of an application. By executing the application, recharging through the process as described above is again performed, and the application is again executed.

Next, other embodiments of battery used in the above-mentioned embodiment will be described.

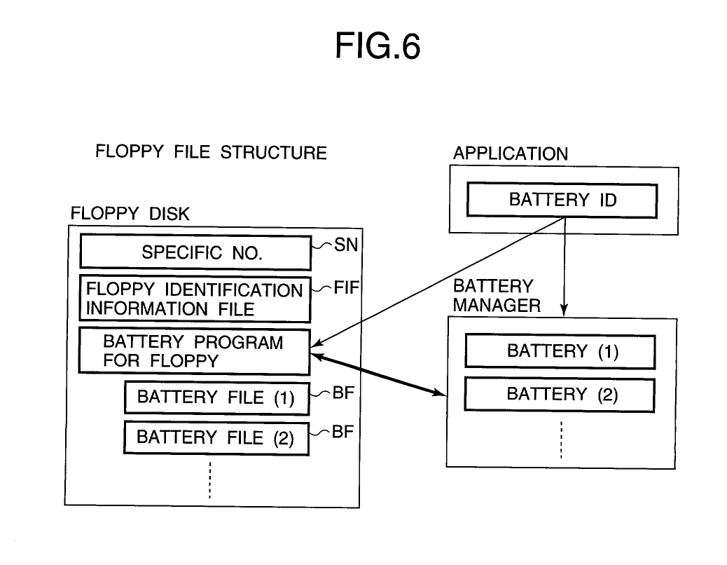

As a member for controlling the use of software, information for controlling the use of software in a memory, for example, a floppy is used, and, since the use of software is controlled, it is called battery. As shown in FIG. 6, the structure of battery is an area stored in a specific number sn of the floppy. Besides, an area for storing a floppy identification information file FIF. This stores information whether the floppy is legitimate or illegal (for example, for judging whether or not it is illegally generated). Further, an area for storing a battery program for the floppy is provided. This battery program is a program having a function of communicating with a battery manager in the user machine upon replenishment/detaching of battery, and selectively handling battery for an application as a starting origin. When this program is called out, the battery ID and an operation mode (one of replenishment and detaching) are designated as parameters upon start.

Finally, an area for storing a battery file BF is provided. This stores a cryptographic file comprising a combination of the battery capacity and information for checking the adaptation of this data. There may be a plurality of such files.

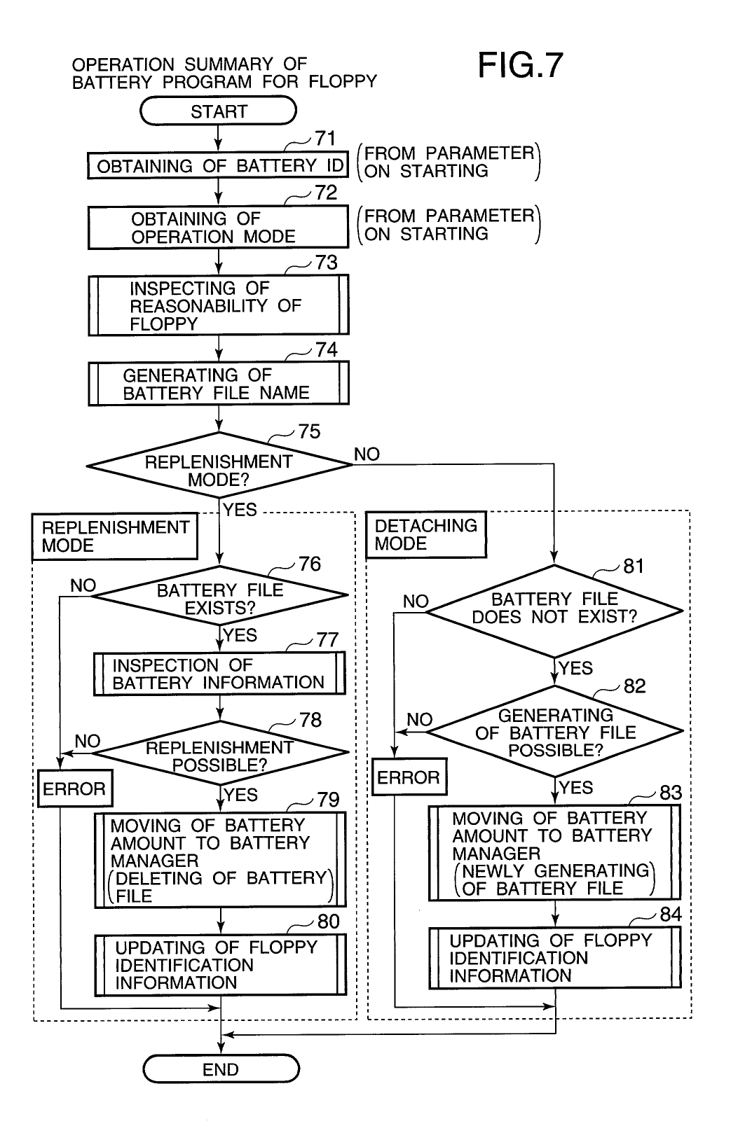

FIG. 7 is a flow showing the above-mentioned battery program, which is stored in the user machine and executed by the processing portion on the user machine PC of FIG. 1.

Hereinafter, the operation will be described in accordance with the flow.

In step 71, arbitrarily giving from parameters upon obtaining starting battery ID, a battery program is written in a area to store. Next, in step 72, obtaining an operation mode is performed. Next, in step 73, reasonability of floppy data in the corresponding storage area is read out, and the contents are confirmed by the processing portion. Next, the flow goes to step 74, in which a battery file name is generated, Next, the flow goes to step 75, in which it is judged whether or not the operation mode is a replenishment mode. If the mode is the replenishment mode, the flow goes to step 76. It is checked whether or not a battery file exists in the floppy. If it exists, the flow goes to step 77, in which battery information is inspected. When it is completed, it is checked whether or not battery can be replenished, and the flow goes to step 79. The battery amount is transferred to the battery manager of the user machine PC. The file of the floppy is deleted. Next, identification information of the floppy is updated and terminated. If the operation mode is a detaching mode, information is taken out from the floppy whether or not the battery file exists, and it is checked. If it does not exist, it is checked whether or not the battery file can be generated. If so, the battery file is generated and the battery amount is moved from the battery manager. Next, the identification information of the floppy is updated.

by constructing as described above, and storing identification information, illegally copying the floppy can be prevented.

Besides, by storing a program in the floppy, self-check of format information of the floppy becomes possible.

Besides, it becomes possible that adaptability of battery information is made to be able to be self-checked.

By communicating with the battery manager of the user machine, battery can selectively be handled.

By version-up of the program, the secrecy of battery information of the floppy can be raised.

Besides, a plurality of battery files can be generated in one floppy.

Next, other embodiments of battery will be described.

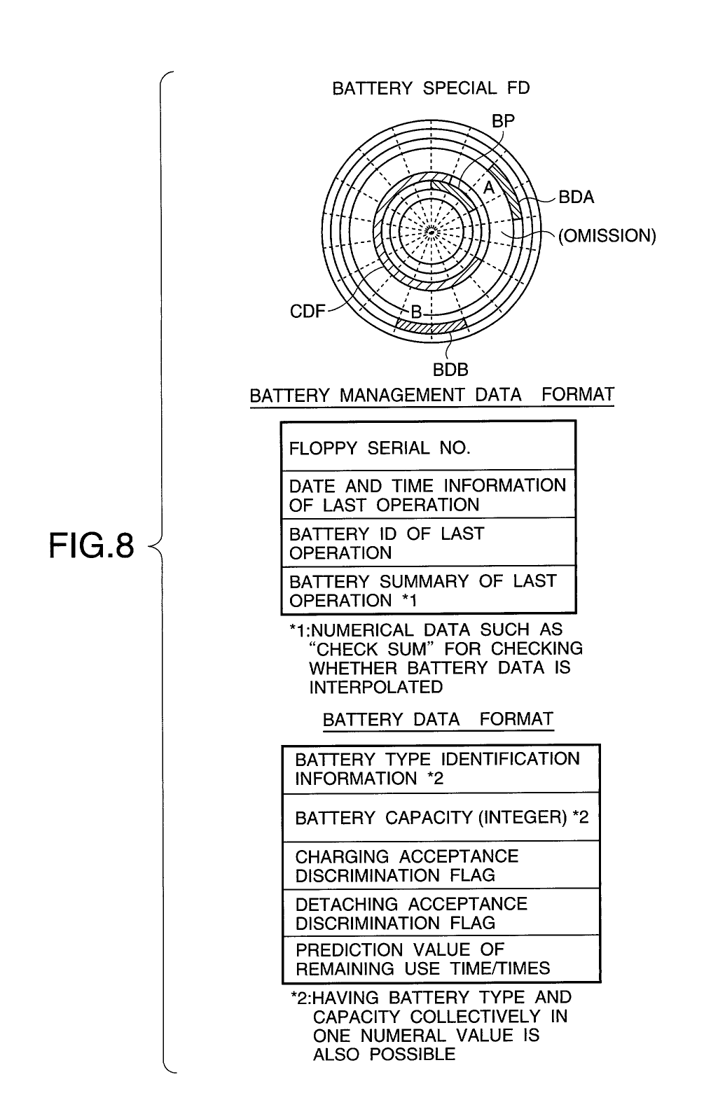

FIG. 8 is an illustration for making battery types.

Shown in the figure, an example in which a floppy is used battery special will be described. In the figure, BP shows an area for storing a battery program. CDF is an area for storing a data file for management. BDA shows an area for storing battery data. Here, battery data A is stored. It is data for controlling an application program A. Data for executing for a predetermined time is stored. Here, it is called normal battery.

BDB is data that battery data B is stored as data for controlling an application program B. Data that the application b can unlimitedly be used is stored. Here, it is called unlimited battery.

As shown in FIG. 8, the format of a management data file is provided with an area for storing the serial number of the floppy, an area for storing date information last operated, and area for storing the battery ID last operated, and an area for storing the summary of the battery last operated. The battery data format is provided with an area for storing identification information on battery types (here, because three types of trial, normal, and unlimited batteries are provided, information for discriminating the three is assigned), an area for storing the battery capacity, an area for storing a charging acceptance discrimination flag, and an area for storing a detaching acceptance discrimination flag and a prediction value of remaining use time/times. Next, the use of the above-described battery will be described.

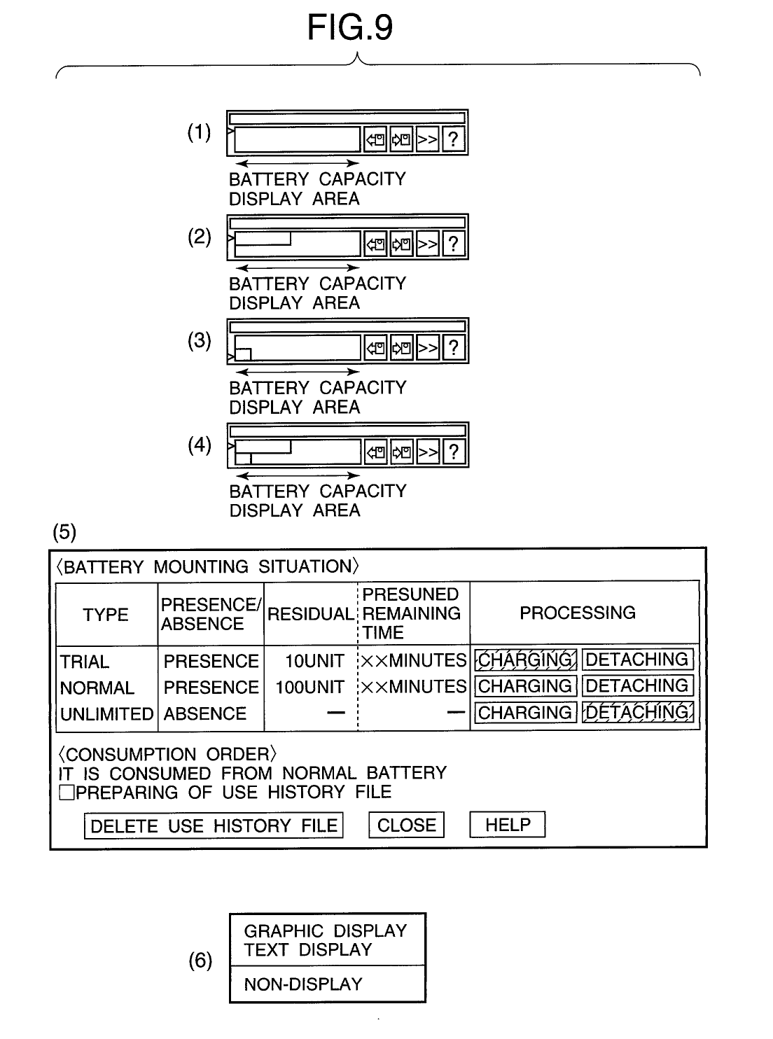

FIG. 9 shows an example of display when battery is used. In FIG. 9,

(1) is an illustration displaying a condition that unlimited battery or normal battery full in its capacity is mounted on a device.

(2) is an illustration showing an example of displaying a condition that one normal battery consumed by about 55% is mounted.

(3) is an illustration showing an example of display of a condition that one trial battery is mounted on the device.

(4) is an illustration showing a condition that two of normal and trial batteries are mounted. In this case, the normal battery is first consumed.

(5) is an illustration for explaining a mounting condition of a battery in text display, and displaying a status of a battery mounted on the application being used. It is constructed such that which battery is consumed is displayed.

(6) is an illustration for explaining an example of display for making the display form of battery possible to select graphic display or text display.

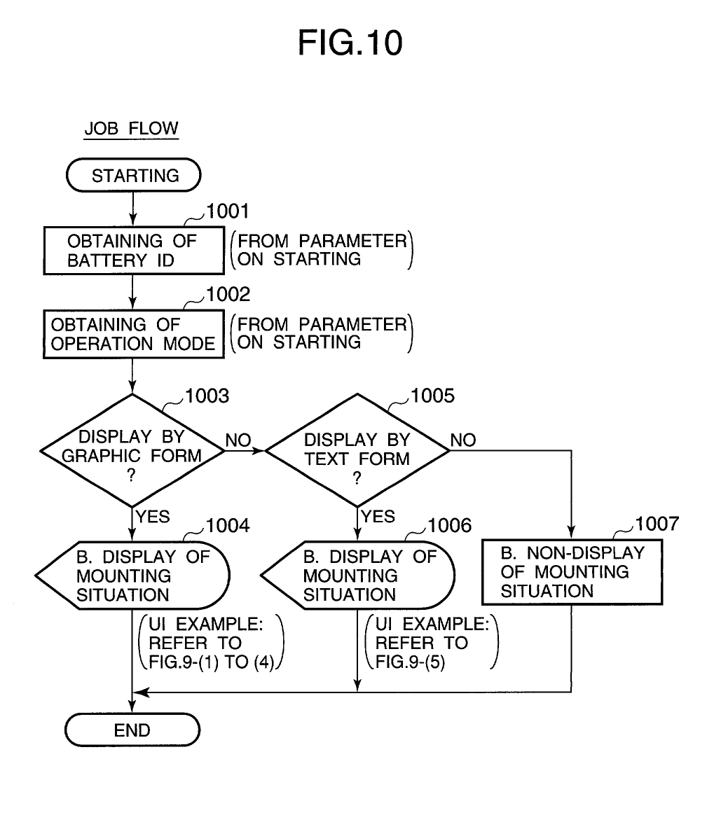

FIG. 10 shows a control flow for controlling display of battery of the above description. Such a control flow is a control made on the user machine PC. A program according to the control flow is stored in a memory, and it is executed by a processing portion to make a control. The following steps are executed by the processing portion.

The display control will be described with reference to FIG. 10.

In step 1001, a battery ID is obtained. Next, an operation mode is obtained. Next, in step 1003, it is judged whether or not it is graphic display. If graphic display is selected, processing of displaying the mounting situation of battery is performed, and display data as shown in the last figure is generated and displayed on a display. In step 1003, if NO, it is judged whether or not it is text form. If so, in step 1006, display data of mounting situation is generated, and display shown in (5) is made.

If NO in step 1005, processing is ended without performing display control of mounting situation.

Next, use prediction of battery mounted on a device will be described.

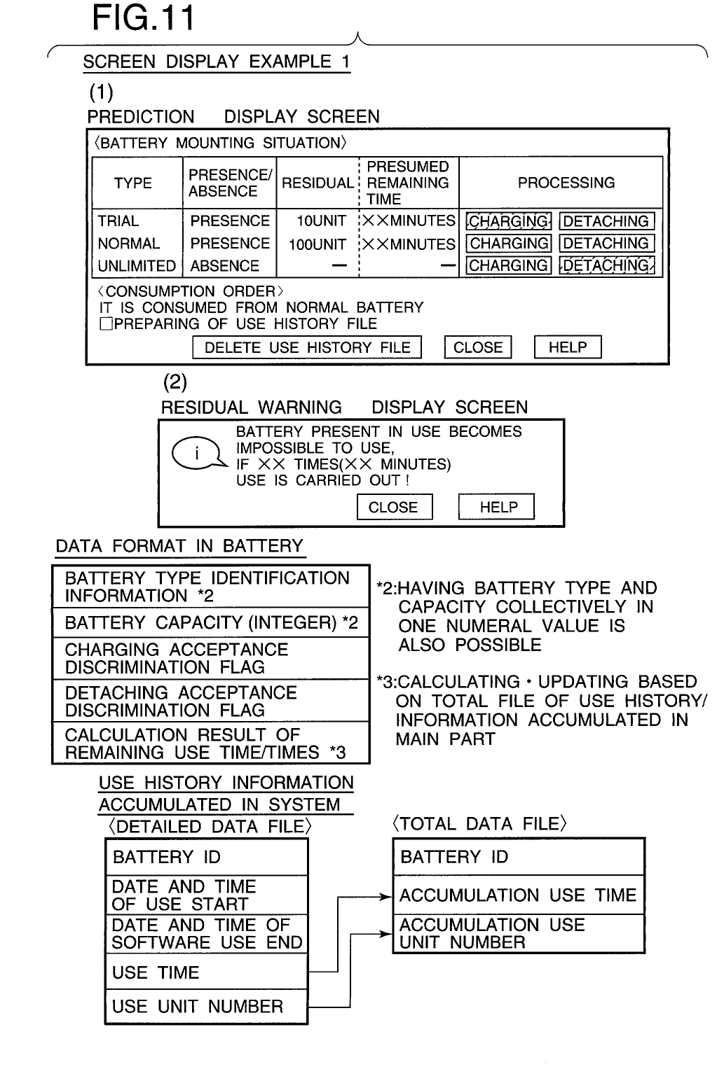

FIG. 11 shows display windows of use prediction of battery. (1) shows one of prediction windows, and (2) shows another example of prediction window.

To predict, the data format of battery is constructed as shown in FIG. 11.

The data format is made up from an area for storing battery type discrimination information, an area for storing the battery capacity, and an area for storing a charging acceptance discrimination flag, a detaching acceptance discrimination flag, and a calculation result of remaining use time/times. Besides, as use history information accumulated in the system, areas for storing a battery ID, date and time of use start, date and time of soft use end, use time, and use unit number are provided. Besides, as a total data file, areas for storing a battery ID, accumulation use time, and accumulation use unit number are provided.

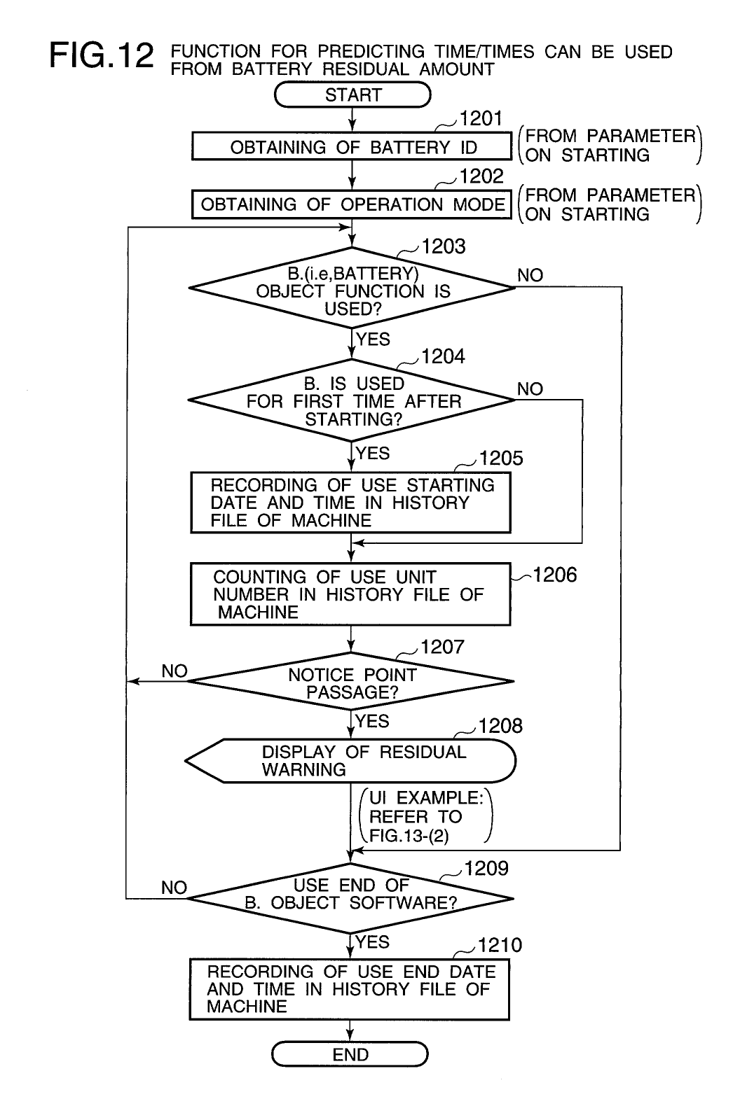

Next, processing of predicting time can be used from the control flow shown in FIG. 12 will be described. Such a control flow is a control made on the user machine PC. A program according to the control flow is stored in a memory, and it is executed by a processing portion to make a control. The following steps are executed by the processing portion.

First, in step 1201, a battery ID is obtained. In step 1202, an operation mode is obtained. The flow goes to the next step 1203, in which it is judged whether or not an object function is used. If YES, the flow goes to step 1204, in which it is judged whether or not battery is used for first time after starting. If YES, in step 1205, use starting date and time are recorded in a history file of the machine. In the next step, use unit number is counted in the history file of the machine. In step 1206, it is judged whether or not notice point is passed. If passed, in step 1208, processing of displaying residual warning is performed and display is made on a display. Next, in step 1209, it is judged whether or not the use of the object software is ended. If NO, the flow again goes to step 1203, and the above processing is repeated. If ended, the flow goes to step 1210, use end date and time is recorded in the history file of the machine and ended.

Next, processing of charging battery will be described with reference to a figure.

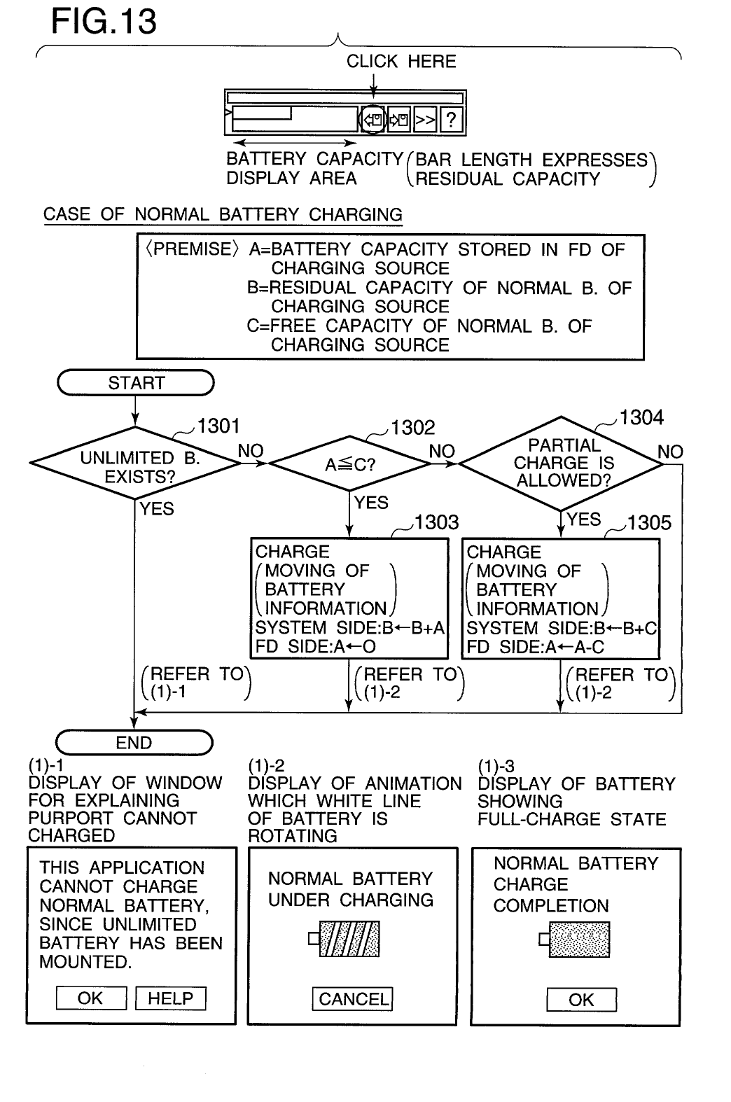

FIG. 13 shows a flow for charging. Such a charge control flow is a control made on the user machine PC. A program according to the control flow is stored in a memory, and it is executed by a processing portion to make a control. The following steps are executed by the processing portion.

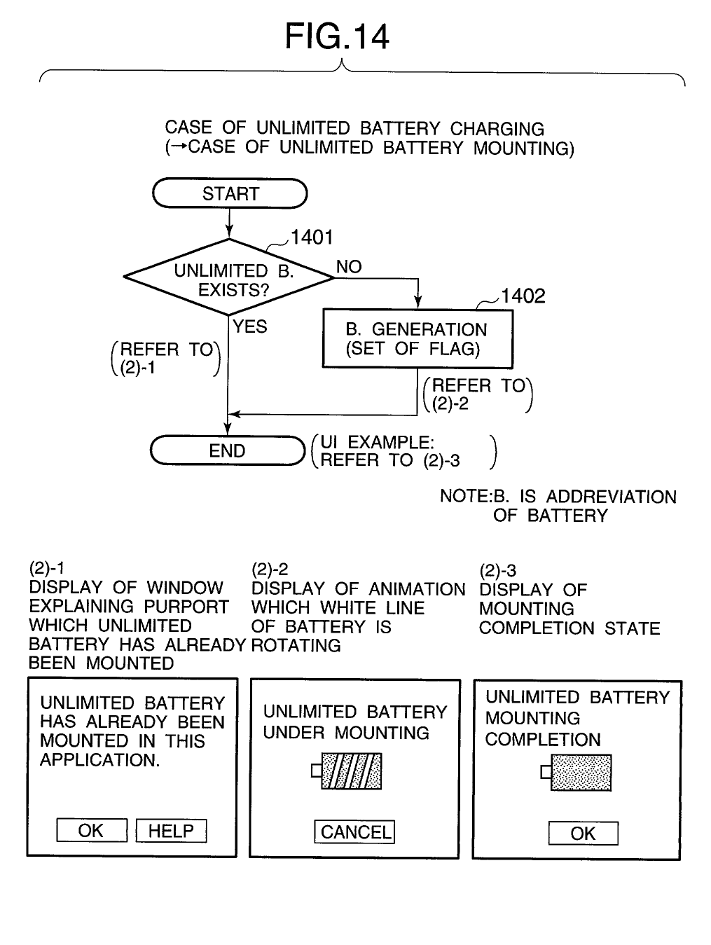

In step 1301, it is judged whether or not charging object battery is unlimited battery. If unlimited battery, charging processing is ended. If not, the flow goes to step 1302, in which the residual is checked. If the free capacity is large, in step 1303, charging processing is performed. If charging is performed, charging processing is ended. In step 1304, it is judged whether or not partial charge is allowed. If YES, in step 1305, charging is performed. If charging is completed, charging processing is ended. Next, with reference to FIG. 14, a case of charging unlimited battery will be described.

In step 1402, it is judged whether or not unlimited battery is mounted. If so, as shown in the figure, a notice of that effect is output to the display screen and ended. If there is no unlimited battery in step 1401, a battery is generated, a message as shown in the figure is displayed, and further a message of mounting completion is displayed.

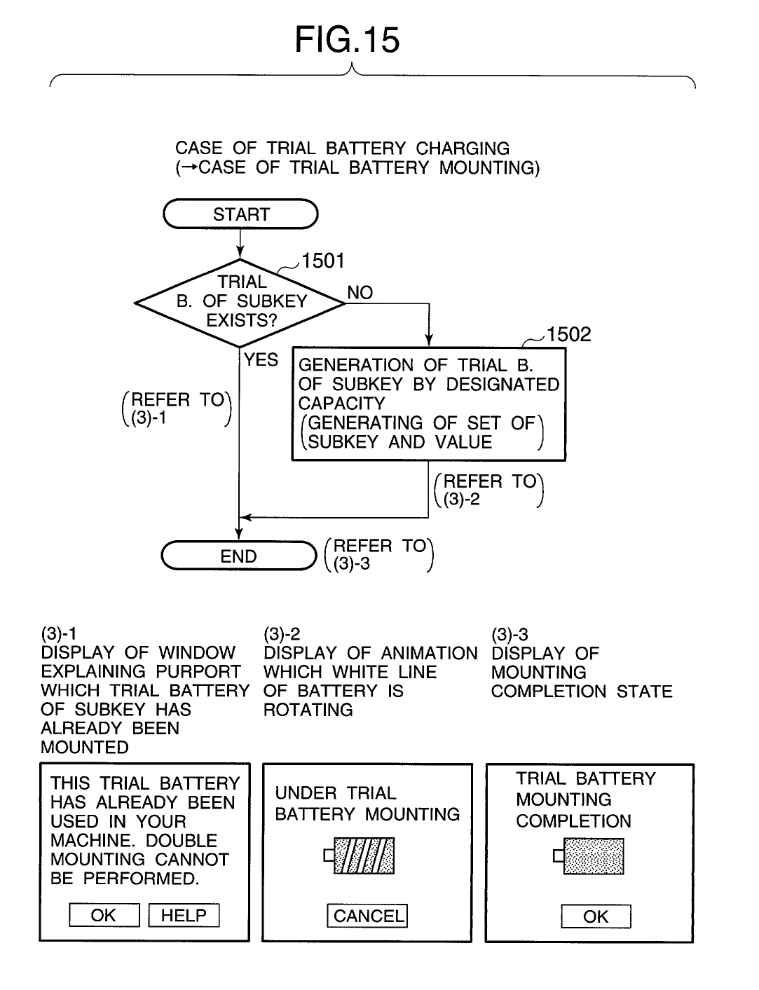

Next, a control flow for charging trial battery will be described with reference to FIG. 15. Such a control flow is a control made on the user machine PC. A program according to the control flow is stored in a memory, and it is executed by a processing portion to make a control. The following steps are executed by the processing portion.

In step 1501, it is judged whether or not trial battery of subkey is mounted. If so, a message as shown in the figure is displayed and terminated. In step 1501, if NO, trial battery of subkey is generated with a designated capacity. At this time, under trial battery mounting in generation as shown in the figure, and, if charging is completed, a message of trial battery mounting completion in the meaning of charging completion as shown in the figure are displayed.

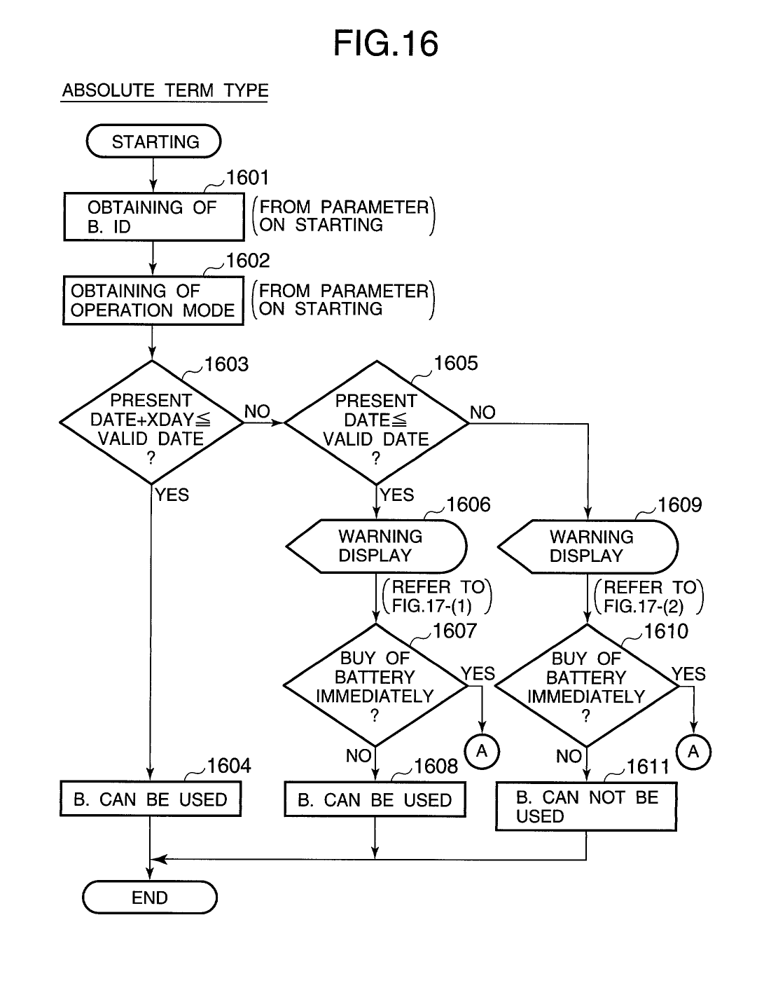

FIG. 16 shows a control flow of processing of, when use limitation of battery and the limitation has come, reproducing it. Such a control flow is a control made on the user machine PC. A program according to the control flow is stored in a memory, and it is executed by a processing portion to make a control. The following steps are executed by the processing portion.

The description is made with reference to the figure. First, in step 1601, an battery ID is obtained. Next, in step 1602, an operation mode is obtained. In the next step 1603, the present date is compared with a valid date. If YES, battery is considered to be usable, and processing of checking whether or not battery is usable is ended. If NO in step 1603, in step 1605, the present date and the valid date are further checked. If YES, in step 1606, data of warning display is generated and displayed on a display. Next, if “buying immediately” is operated, the flow shifts to a battery buying routine. If NO, since battery can be yet used, in step 1608, processing for battery being usable is performed, and such processing is ended. If the result of NO is obtained in step 1605, in step 1609, data of warning display is generated and displayed on a display. In step 1610, it is checked whether or not the window is next clicked. Processing whether the flow shifts to a buying routine or, immediately, the flow goes for operating the device is performed. If this is completed, this processing is ended.

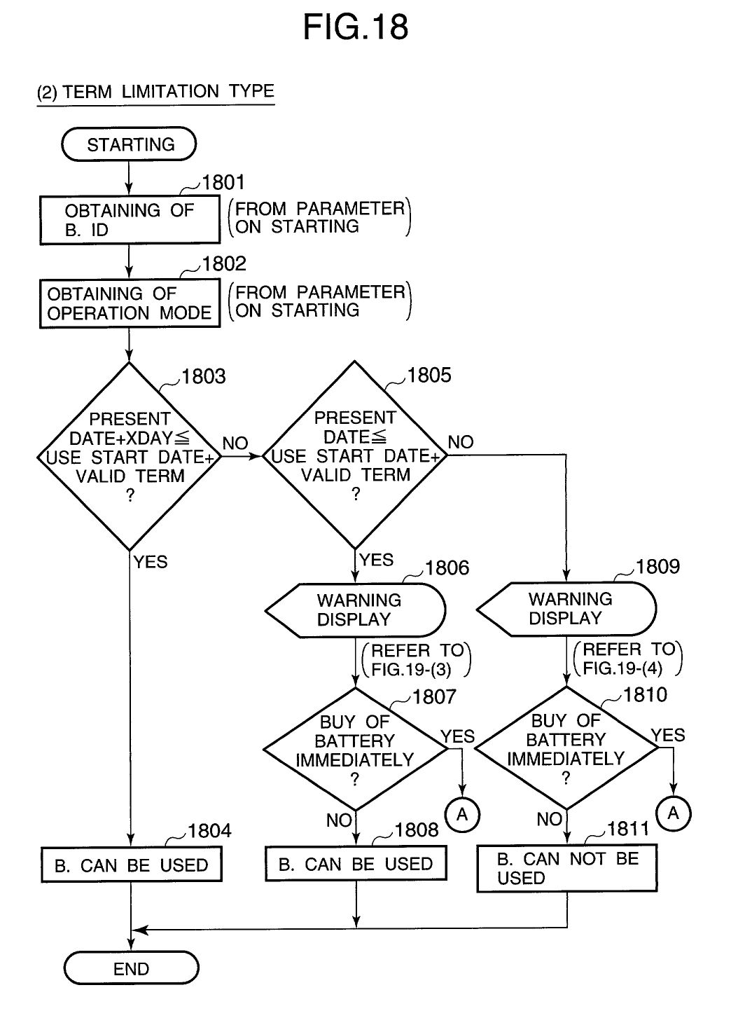

FIG. 18 shows a flow for checking whether battery is bought or continuously used when battery is a term limitation type. Such a control flow is a control made on the user machine PC. A program according to the control flow is stored in a memory, and it is executed by a processing portion to make a control. The following steps are executed by the processing portion.

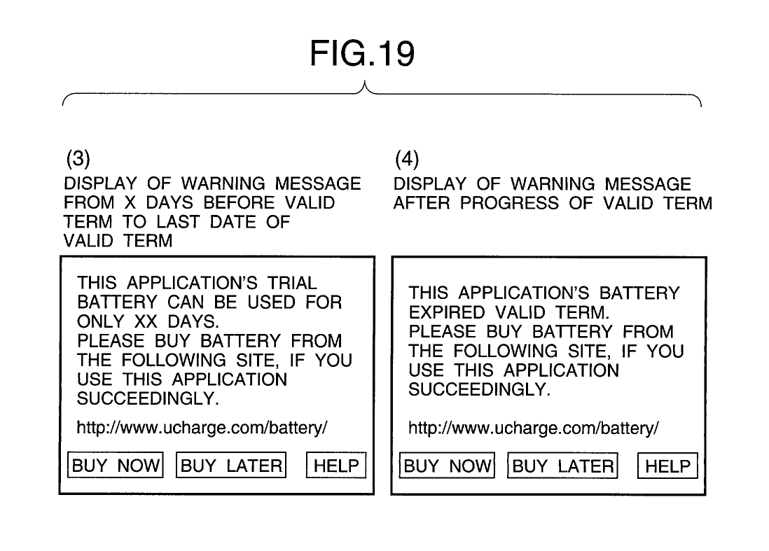

In FIG. 18, in step 1801, a battery ID is obtained. Next, in step 1802, an operation mode is obtained. After this, in step 1803, comparison with present date+X and use start date+valid term is made. If YES, battery is considered to be usable, processing is made in step 1804, and such processing is ended. If NO in step 1803, the present date is compared with use start date+valid term. If YES, in step 1806, a warning display is made as shown in FIG. 19. An instruction for buying now or later is processed. If the instruction is for buying now, the flow shifts to buying processing. If not, in step 1808, processing for battery being usable is performed, and this processing is ended. If NO in step 1805, in step 1809, a warning display is made. As shown in FIG. 19, the flow shifts to processing of waiting for an instruction. In accordance with the instruction, processing is performed as described above, and this processing is ended.

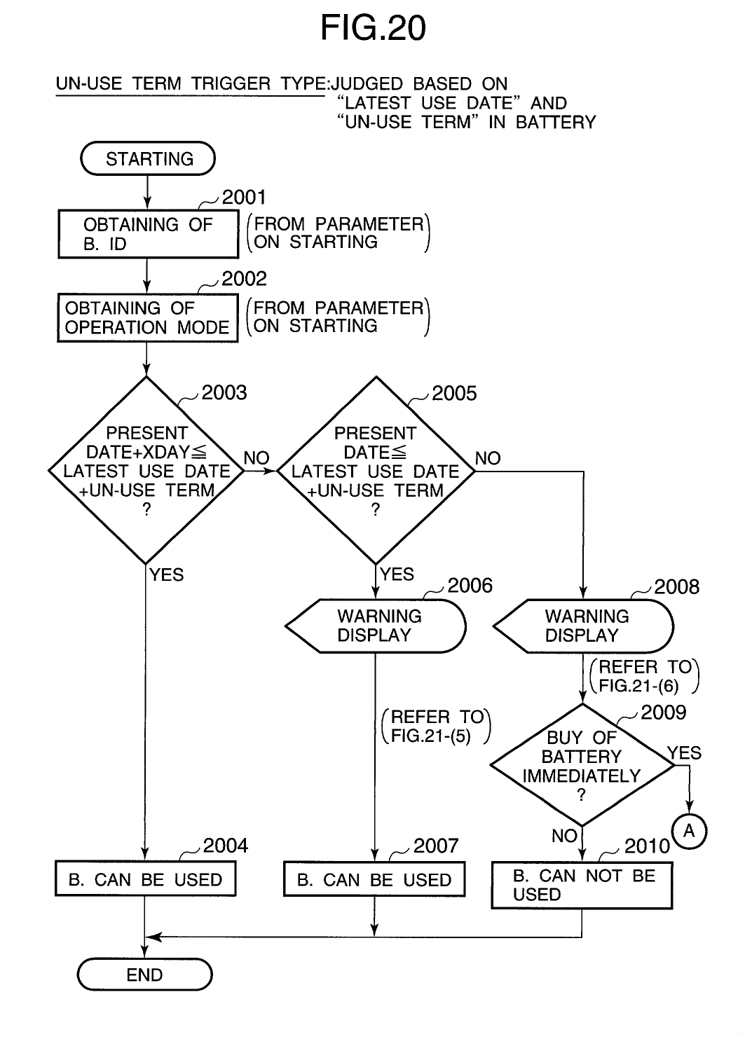

Next, control processing whether battery of an un-use term trigger type is continuously used or battery is bought will be described with reference to FIG. 20. Such a control flow is a control made on the user machine PC. A program according to the control flow is stored in a memory, and it is executed by a processing portion to make a control. The following steps are executed by the processing portion.

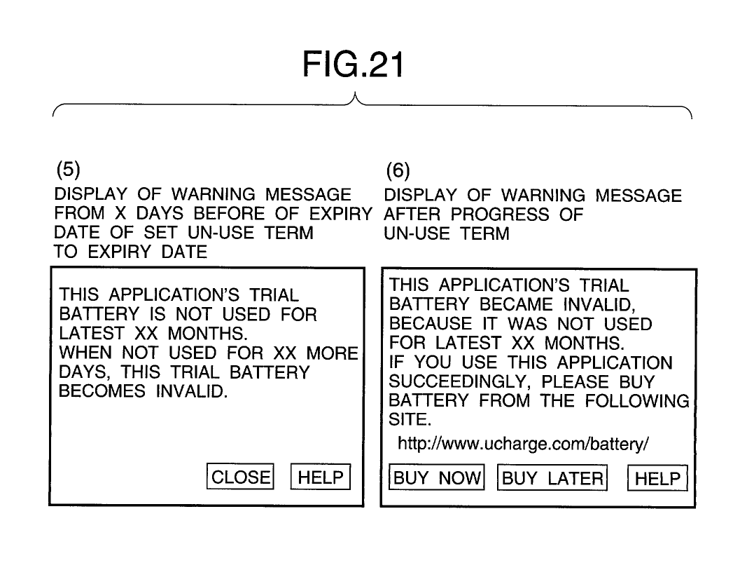

In FIG. 20, in step 2001, a battery ID is obtained. Next, in step 2002, an operation mode is obtained. After this, in step 2003, the present date+X is compared with latest use date+un-use term. If YES, battery is considered to be usable, processing is made in step 2004, and such processing is ended. If “NO” in step 2003, in step 2005, the present date is compared with latest use date+un-use term. If YES, in step 206, a warning display is made as shown in FIG. 21. In step 2007, processing for battery being usable is performed, and this processing is ended. If “NO”, in step 2008, a warning display is made. As shown in FIG. 19, the flow shifts to processing of waiting for an instruction. It is judged whether or not battery is bought now. If NO, processing for battery being not usable is performed. If battery is bought, processing to shift to a buying routine is performed, and this processing is ended.

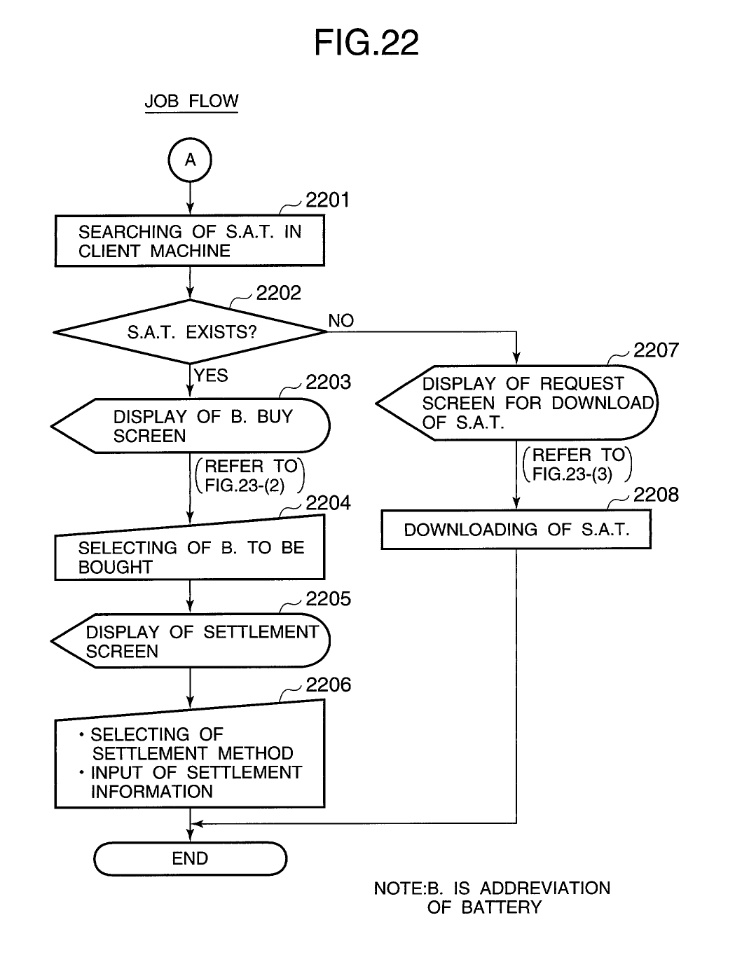

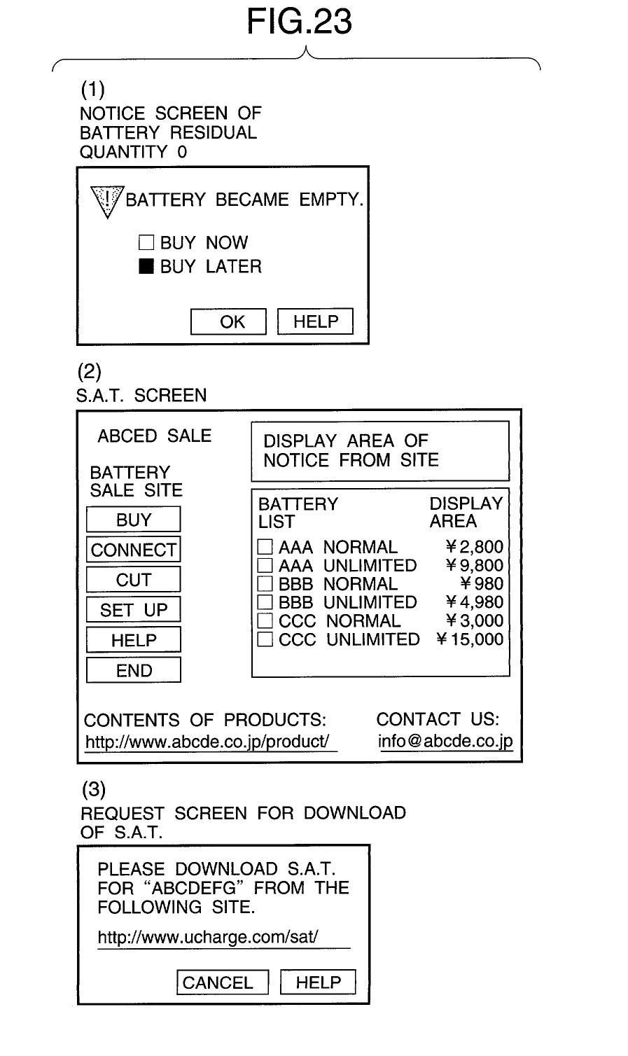

FIG. 22 shows a flow of battery buying processing. Such a control flow is a control made on the user machine PC. A program according to the control flow is stored in a memory, and it is executed by a processing portion to make a control. The following steps are executed by the processing portion. The description of processing is made with reference to the figure. In FIG. 22, in step 2201, it is searched whether or not S.A.T. in a client machine exists. The result is judged in step 2202. If it exists, in step 2203, a buy screen is generated, and, for example, displayed as shown in FIG. 23. In step 2204, a selection operation for buy battery is waited for. In step 2205, settlement screen display processing is performed and displayed. Waiting processing of input of selection settlement information of settlement method is ended.

In step 2202, in case of “NO”, in step 2207, a download request screen of S.A.T. is generated. The display is displayed as shown in FIG. 23. If a clicking operation is performed, it is downloaded from the displayed site.

Next, a control flow in case of a plurality of battery buy sites will be described. Such a control flow is a control made on the user machine PC. A program according to the control flow is stored in a memory, and it is executed by a processing portion to make a control. The following steps are executed by the processing portion.

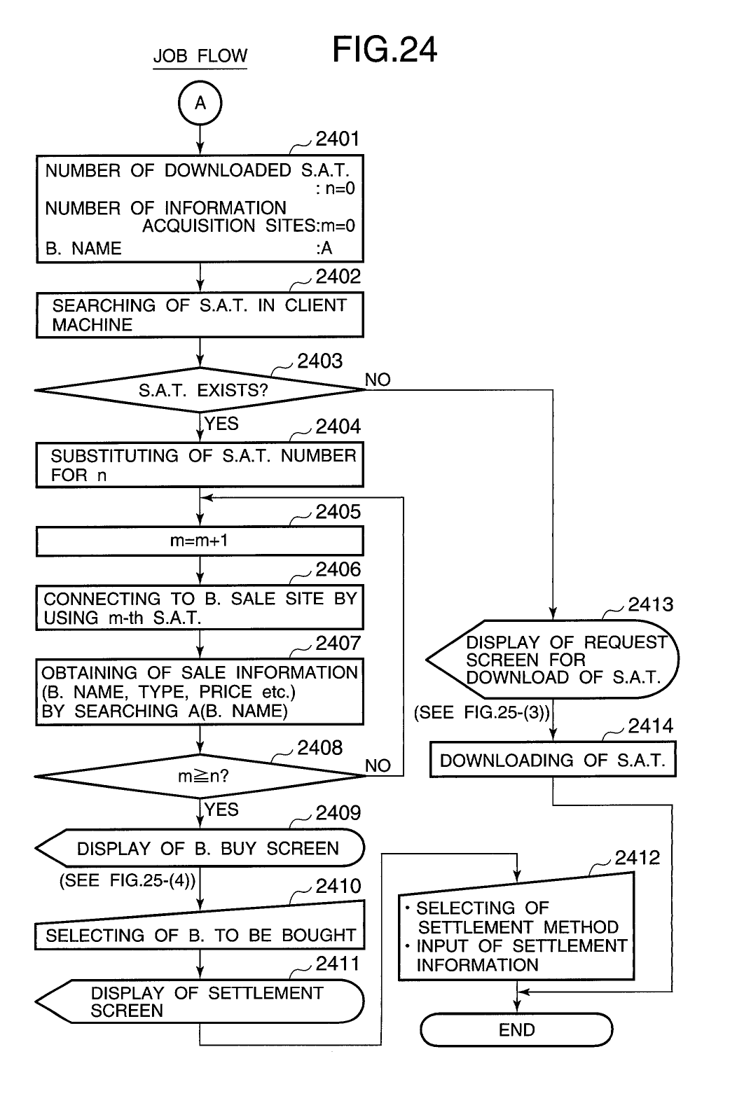

FIG. 24 shows an example wherein, when a plurality of SATs (Site Access Tools) exist in a user's machine, battery to be bought is searched in all SATs, and the result is displayed.

By incorporating this function, the user can buy battery after comparing the price with those of the other sites.

In step 2401, a parameter for the number of download sites is set. In step 2402, the number of site access tools on the client machine is searched. If a site access tool exists in step 2403, in step 2404, the number of site access tools is entered in n. Next, in step 2305, M=M+1 is executed. Next, in step 2406, using the M-th site access tool, a connection with the buttery sale site is made. A (battery name) is searched and the sale information is obtained. For example, a battery name, type, and price, or the like.

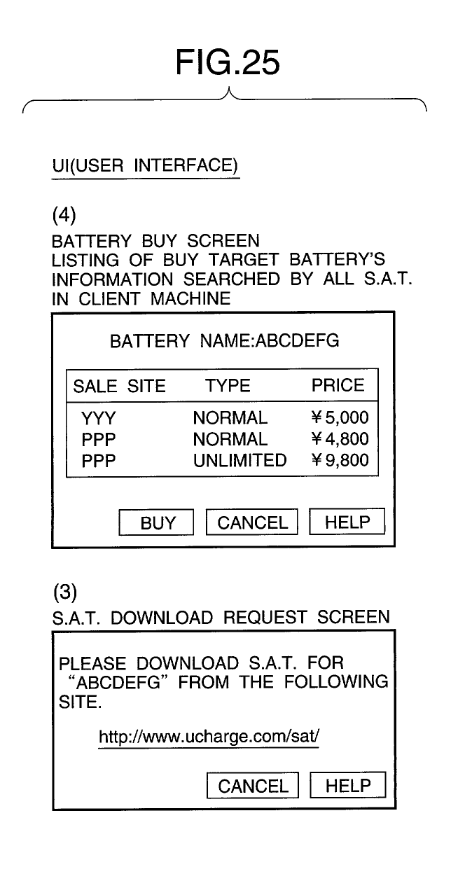

It is judged whether or not M≧N. If “YES”, a battery buy screen is displayed as shown in FIG. 25. Next, by operating the screen, in step 2410, buy battery is selected. Next, in step 2410, a settlement screen is displayed. In step 2412, selection of settlement method and settlement information are input.

In case of “NO” in step 2403, in step 2413, a download request screen of a site access tool is generated and displayed on the screen as shown in FIG. 25.

Next, handling when battery is invalid will be described.

When battery is invalid, imposing the charge fee of battery is performed as follows. In case of prepayment, “price corresponding to unused amount—predetermined fee for disengagement” is paid back. The unused amount is calculated from “battery residual amount”.

The sum of money is calculated after the battery sale source has withdrawn invalid battery from the user, and it is notified to the user. Imposing the fee when battery is invalid is made to be applicable to normal/unlimited battery.

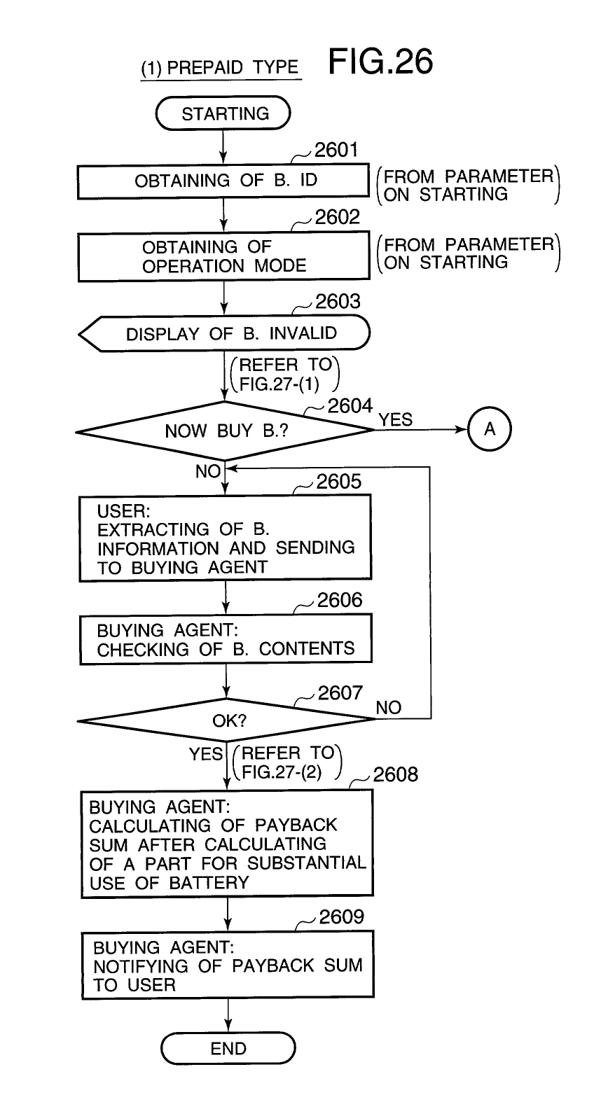

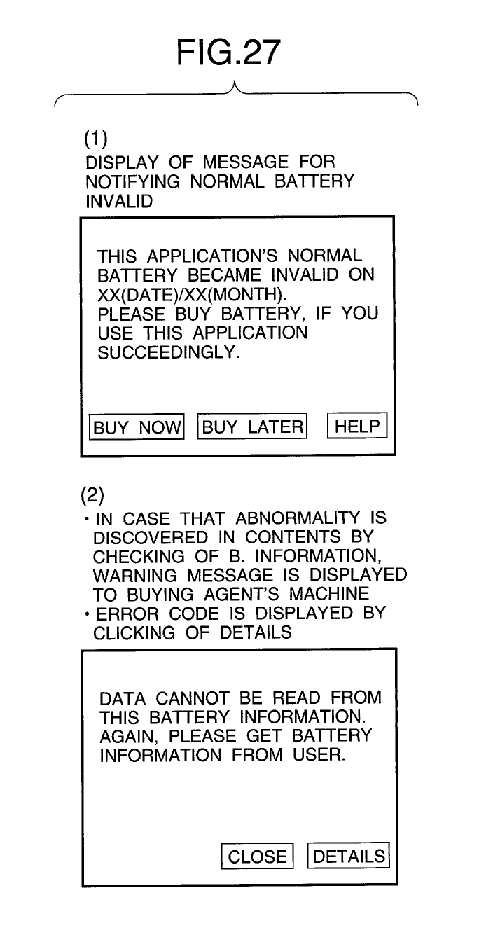

Next, a description is made with reference to the control flow of FIG. 26. Such a control flow is a control made on the user machine PC. A program according to the control flow is stored in a memory, and it is executed by a processing portion to make a control. The following steps are executed by the processing portion. First, in step 2601, a battery ID is obtained. Next, in step 2602, an operation mode is obtained. In step 2603, a display of battery invalid is generated, and a display of that effect is made on the screen as shown in FIG. 27. Next, when an icon “buy battery now” is operated, the flow shifts to step 2201 of FIG. 22 of battery buy processing.

If “NO”, battery information of the user is extracted and sent to the buying agent. The buying agent checks the battery contents. In step 2607, it is checked whether or not it is acceptable. If “NO”, a display is made as shown in FIG. 27.

If “YES” in step 2607, after a buying agent calculates battery substantial use part, the payback sum is calculated. Next, the payback sum is notified to the user by the buying agent, and processing is ended.

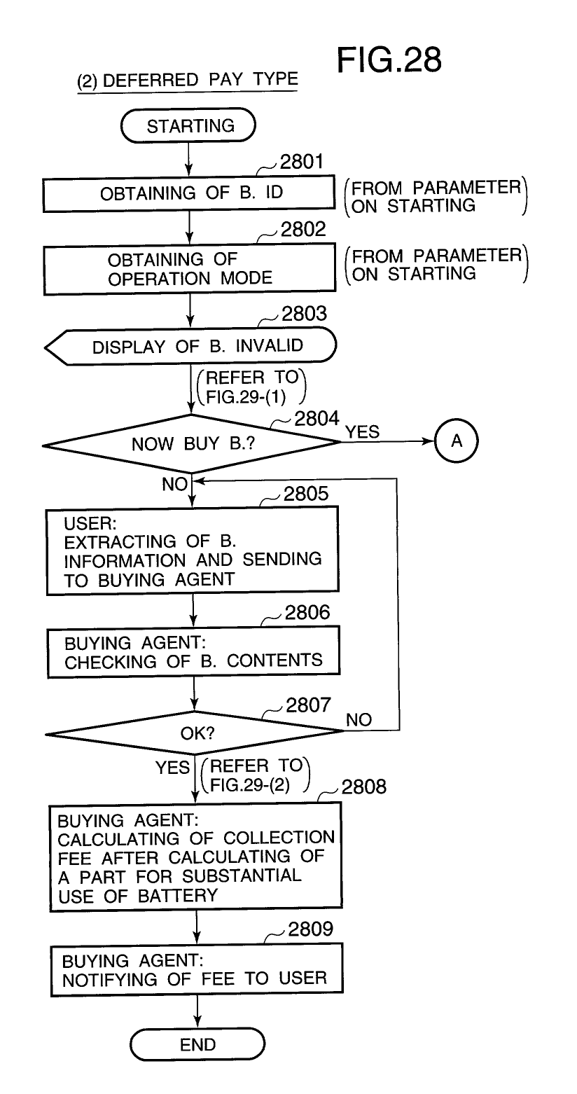

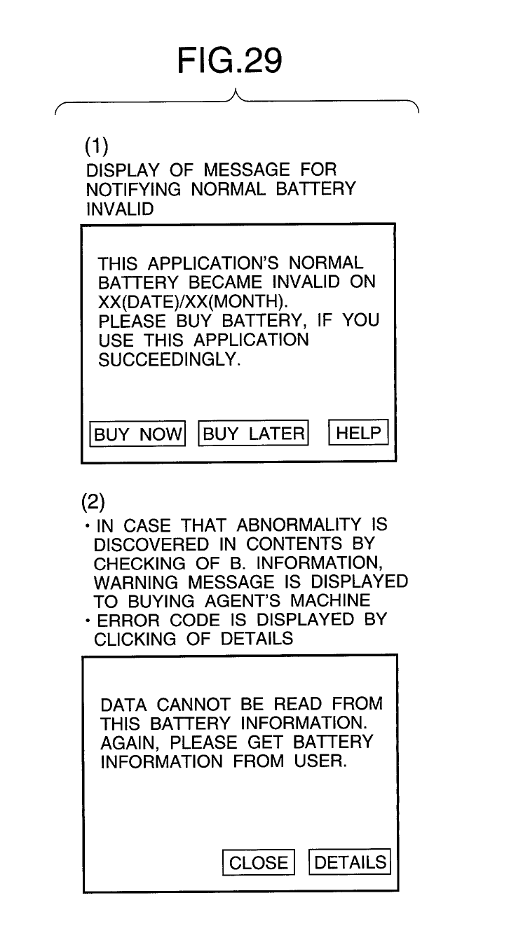

Next, the control flow shown in FIG. 28 will be described. Such a control flow is a control made on the user machine PC. A program according to the control flow is stored in a memory, and it is executed by a processing portion to make a control. The following steps are executed by the processing portion. First, in step 2801, a battery ID is obtained. Next, in step 2802, an operation mode is obtained. In step 2803, a display of battery invalid is generated, and a display of that effect is made on the screen as shown in FIG. 29. Next, when an icon “buy battery now” is operated, the flow shifts to step 2201 of FIG. 22 of battery buy processing.

If “NO”, battery information of the user is extracted and sent to the buying agent. The buying agent checks the battery contents. In step 2807, it is checked whether or not it is acceptable. If “NO”, a display is made as shown in FIG. 29.

If “YES” in step 2807, after a buying agent calculates battery substantial use part, the collection fee is calculated. Next, the fee is notified to the user by the buying agent, and processing is ended.

Next, an example wherein the generation of a battery FD can be performed by, for example, a device placed in a convenience store will be described.

The operation will be described.

First, a user designates a type of software and a payment method through the device of the convenience store.

Next, when battery is requested, an FD is set in a terminal. Reading out from the FD is made. A serial number specific to the terminal is sent from the terminal to a server. As such a serial number, cryptographic data is generated. Besides, the server also sends cryptographic battery source data to the terminal.

After this, on the terminal side, the cryptogram is decoded. After adaptation between the sent serial number and the terminal specific serial number is checked, battery data is generated.

Besides, a user registration is made to be performed by the terminal of the convenience store. Besides, if battery is generated in the FD using a prepaid card, anonymity can be kept.

Further, an FD in which only key data has been written is sold in a convenience store. Using this FD, a change from a trial version to a product version on off-line, or version-up by a charge can be made.

According to the present invention:

because information for charging battery is not transmitted as a file but a communication through a program is always made, copying through a simple work such as copying the file becomes difficult;

of provided batteries, because battery already used by a user and battery not so can be discriminated, the user does not confuse in operation; and

because confirmation information upon charging battery is recorded in log of a host machine, means for ensuring that right charge is performed, to a user machine can be provided.

Because types of batteries are provided, management of software can unitarily be managed. Because types of batteries are provided, since control of restoration can be controlled in accordance with those, a system easy to use from the view of a user can be provided.

What is claimed is:

1. A storage medium storing software and management software for managing said software, wherein said management software comprises a step of restoring and changing a management state of said software.

2. The storage medium according to claim 1, wherein said storage medium stores a predetermined address and connects to said address for the restoring and changing.

3. An information processing apparatus comprising storing means for storing management software for managing software, wherein said management software comprises:
means for restoring and changing a management state of said software; and
means for connecting to a predetermined site for restoring a management state of said management software by said restoring means.

4. The information processing apparatus according to claim 3, further comprising means for receiving information from the predetermined site and storing it in said storing means.

5. An information processing apparatus comprising:
means for restoring and changing a management state of management software for managing software; and
means for connecting to a predetermined site for restoring a management state of said management software by said restoring means.

6. The information processing apparatus according to claim 5, further comprising selecting means for restoring the management state by said restoring and changing means.

7. A host device which communicates with an information processing apparatus to restore a management state of management software, said information processing apparatus comprising:
means for restoring and changing the management state of said management software for managing software; and
means for connecting to a predetermined site for restoring the management state of said management software by said restoring means,
said host device comprising means for transmitting information for restoring the management state of said management software in response to a request from said information processing apparatus.

8. The host device according to claim 7, further comprising means for storing information which restores the management state for a plurality of pieces of management software.

9. A storage medium for controlling the use limitation of software comprising a storage area for storing type information indicating a type of use limitation of software, and a storage area for storing information representing the use limitation.

10. The storage medium according to claim 9, storing information meaning one of trial, normal and unlimitedness as said type information.

11. The storage medium according to claim 9, further comprising an area for storing management data.

12. A management apparatus comprising a storage portion for controlling the use limitation of software comprising a storage area for storing type information indicating a type of use limitation of software, and a storage area for storing information representing the use limitation, and means for changing the contents of said storage portion on the basis of the use of software corresponding to said storage portion.

13. The management apparatus according to claim 12, wherein a plurality of said storage portions are disposed.

14. The management apparatus according to claim 12, further comprising a storage portion in which software corresponding to said storage portion is disposed.

15. A management apparatus comprising a storage portion for controlling the use limitation of software comprising a storage area for storing type information indicating a type of use limitation of software, and a storage area for storing information representing use limitation, a software storage portion for storing software corresponding to said storage portion, and means for changing the contents of said storage portion on the basis of the use of said software corresponding to said storage portion.

16. The medium according to claim 9, further comprising a storage area for storing a plurality of pieces of type information.

17. An information processing apparatus comprising:
means for restoring and changing a management state of management software for managing software;
means for connecting to a predetermined site for restoring the management state of said management software by said restoring means; and
control means for displaying a message concerning the restoration and change of software sent from said predetermined site.

18. A host device to communicate with an information processing apparatus comprising means for restoring and changing a management state of management software for managing software, and means for connecting to a predetermined site for restoring a management state of said management software by said restoring means, said device thereby restoring the management state of said management software,
said device comprising:
control means for transmitting a message concerning the restoration and change of software to said information processing apparatus; and
means for transmitting information for restoring the management state of said management software.

19. The device according to claim 18, wherein said control means has a function of transmitting said message with appending information indicating the supply source of said restoring information.
